(19) United States
(12) Patent Application Publication
(10) Pub. No.: US 2009/0097597 A1
(43) Pub. Date: Apr. 16, 2009

(54) Methods For Coarse Frequency Offset Estimation For Orthogonal Frequency Division Multiplexing Schemes

(75) Inventors: Junqiang Li, Sunnyvale, CA (US); Baoguo Yang, San Jose, CA (US); Yue Chen, Fremont, CA (US)

Correspondence Address: Venture Pacific Law, PC, 5201 Great America Parkway, Suite 270, Santa Clara, CA, 95054, US

(73) Assignee: AUGUSTA TECHNOLOGY, INC., Santa Clara, CA (US)

(21) Appl. No.: 12/252,344

(22) Filed: Oct. 15, 2008

Related U.S. Application Data
(60) Provisional application No. 60/980,142, filed on Oct. 15, 2007.

(51) Int. Cl. H04L 27/06

(52) U.S. Cl. 375/344

(57) ABSTRACT

The present invention provides methods for coarse frequency offset estimation, where those methods may comprise the steps of: removing fading channel impact by calculating accumulated correlation values; removing CCI and phase rotation due to large sampling offset by calculating an accumulation metric as a function of the accumulated correlation values, CCI peak, and initial sampling offset, ξ; and finding the coarse frequency offset as a function of the accumulation metric.

### CROSS REFERENCE

This application claims priority from a provisional patent application entitled “Coarse Frequency Offset Estimation with CCI and Large Sampling Offset up to 200 PPM” filed on Oct. 15, 2007 and having an Application No. 60/980,142. Said application is incorporated herein by reference.

### FIELD OF THE INVENTION

This invention relates to methods for digital communication, and, in particular, to orthogonal frequency division multiplexing (“OFDM”) modulated signal and coarse frequency offset estimation related thereto.

### BACKGROUND OF THE INVENTION

Orthogonal frequency division multiplexing is a multi-carrier transmission technique that uses orthogonal subcarriers to transmit information within an available spectrum. Since the subcarriers may be orthogonal to one another, they may be spaced much more closely together within the available spectrum than, for example, the individual channels in a conventional frequency division multiplexing (“FDM”) scheme.

In OFDM modulated signals, the subcarriers may be modulated with a low-rate data stream before transmission. It is advantageous to transmit a number of low-rate data streams in parallel instead of a single high-rate stream since low symbol rate schemes suffer less from intersymbol interference (“ISI”) caused by the multipath. For this reason, many modern digital communications systems are turning to an OFDM scheme as a modulation scheme for signals that need to survive in environments having multipath or strong interference. Many transmission standards have already adopted OFDM schemes, including the IEEE 802.11a standard, the Digital Video Broadcasting Terrestrial (“DVB-T”), the Digital Video Broadcasting Handheld (“DVB-H”), the Digital Audio Broadcast (“DAB”), and the Digital Television Broadcast (“T-DMB”).

Although OFDM schemes are advantageous in combating intersymbol interference, it is quite sensitive to frequency deviations. The frequency deviations may be caused by the difference in the oscillator frequency of the receiver and the transmitter, or by the Doppler shift of the signal due to movement of either the receiver or the transmitter. Large frequency deviations cause significant interference between signals at different subcarriers, hence result in dramatic performance degradation. Therefore, it is critical to use frequency offset estimation to correct the frequency deviations for delivering good transmission quality.

There are two other challenging problems (except the reasonable Doppler for 200 Hz in the 8K mode) that significantly impact the performance of coarse frequency offset estimation. The first problem is co-channel interference (“CCI”) due to analog television (“TV”) signals. The signal power of analog TV can be equal to or even larger than the desired signal of DVB-T/H and also in the same spectrum, thereby interfering with the DVB-T/H. The energy of analog TV signals is mainly located at several sub-carriers with 30-40 dB larger than that of DVB-T/H, illustrated in FIG. 1. According to the DVB-T/H specifications, there is only 2.5 dB gain due to power allocation of continual pilots. Thus, the CCI of analog TV can significantly degrade the performance of continual pilots.

The second problem is the large sampling offset, for instance 100 PPM. As is commonly known, the sampling offset introduces phase rotation at each sub-carrier. The phase rotation between two adjacent OFDM symbols is

Δφ=2π(N+N_{g})/N*k*ξ (1)

where k ε(−K/2, K/2), K is the number of useful carriers, N=2K, 4K and 8K depending on the mode, N_{g} is the length of the cyclic prefix, and the sampling clock offset is ε=(T′−T)/T. Based on Equation (1), it is evident that the correlation between two adjacent symbols is reduced if there is a large sampling offset.

Therefore, it is important to find methods for coarse frequency offset estimation that can account for co-channel interference and a large sampling offset.

### SUMMARY OF THE INVENTION

An object of this invention is to estimate the coarse frequency offset for an OFDM modulated signal by taking into account co-channel interference.

Another object of this invention is to estimate the coarse frequency offset for an OFDM modulated signal by taking into account a large sampling offset.

Briefly, according to the present invention, methods for coarse frequency offset estimation in orthogonal frequency division multiplexing schemes are disclosed. These methods for coarse frequency offset estimation may include: removing fading channel impact by calculating accumulated correlation values; removing CCI and phase rotation due to large sampling offset by calculating an accumulation metric as a function of the accumulated correlation values, CCI peak, and initial sampling offset, ξ; and finding the coarse frequency offset as a function of the accumulation metric.

An advantage of this invention is that a large sampling offset is taken into account when estimating the coarse frequency offset for an OFDM modulated signal.

An advantage of this invention is that the co-channel interference due to analog television signals is taken into account when estimating the coarse frequency offset for an OFDM modulated signal.

### BRIEF DESCRIPTION OF THE DRAWINGS

The foregoing and other objects, aspects, and advantages of the invention will be better understood from the following detailed description of the preferred embodiment of the invention when taken in conjunction with the accompanying drawings in which:

FIG. 1 illustrates an energy spectrum of a DVB-T signal with CCI due to analog television signals.

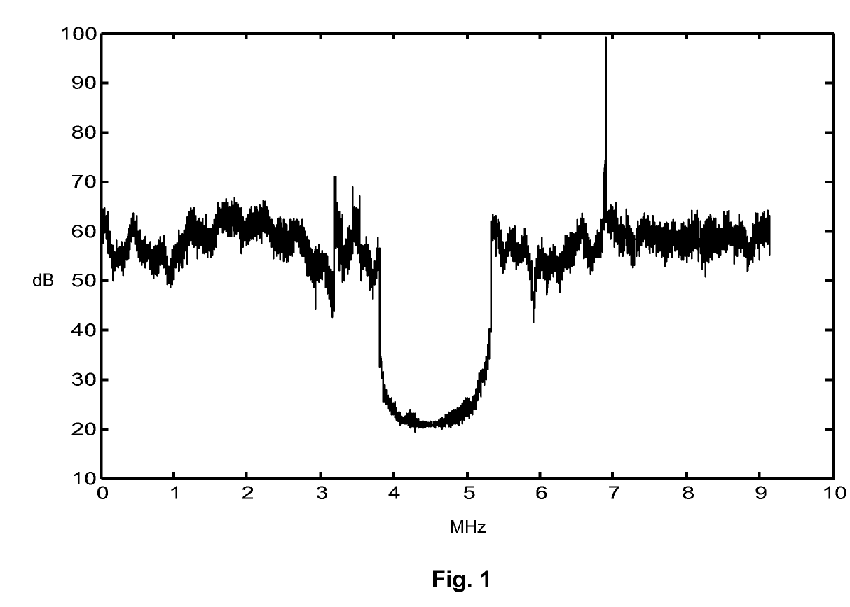

FIG. 2 illustrates examples of possible continual pilot positions for different frequency offsets, n_{I}.

FIG. 3 is a flow chart that illustrates a method of this invention for coarse frequency offset estimation of an OFDM modulated signal.

### DETAILED DESCRIPTION OF THE PREFERRED EMBODIMENTS

The frequency offset includes an integer carrier frequency offset (Δf_{I}),

Δf_{I}=n_{I}·1/Tᵤ (2)

where Tᵤ is the inverse of the carrier spacing and n_{I} is an integer value, and a fractional carrier frequency offset (Δf_{F}), where the total frequency offset is

Δf=Δf_{I}+Δf_{F} (3)

The Δf_{F} can be estimated in the time domain by using the cyclic prefix (“CP”) and trail segments before FFT. The integer part can be estimated after FFT by using continual pilots since the power allocation of pilots is about 2.5 dB higher than that of the adjacent data and TPS signals and since the position pattern of continual pilots is fixed in each symbol, except for the whole position shifting due to frequency offset. There are 45 continual pilots in the 2K mode, 89 continual pilots in the 4K mode, and 177 continual pilots in the 8K mode.

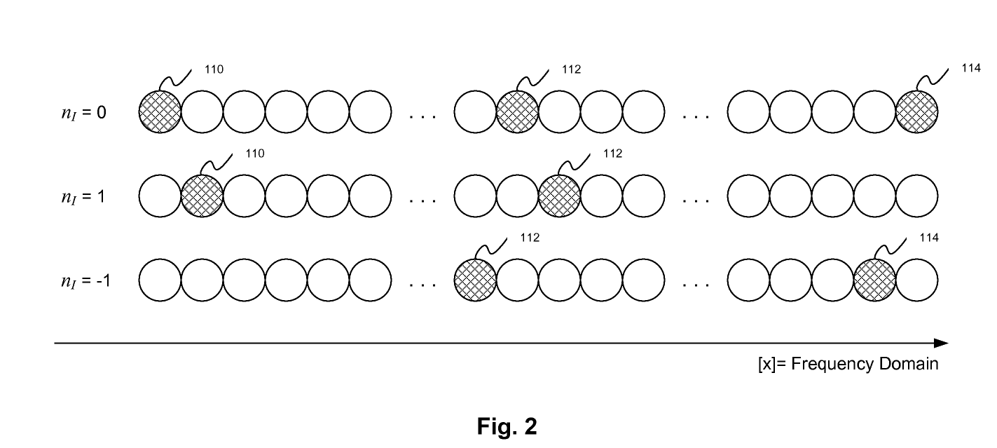

By doing correlation of two consecutive OFDM symbols in the frequency domain, the channel response at each sub-carrier can be removed assuming the Doppler is not large, for instance when f_{d}<0.2Δf. However, the integer frequency offset can cause the position of continual pilots to shift. FIG. 2 illustrates some examples of possible continual pilot positions for different frequency offsets, n_{I}. Referring to FIG. 2, the empty circles are data symbols, and the meshed circles are continual pilots. The original positions of the continual pilots 110, 112, and 114 are shown in the n_{I}=0 row where the integer frequency offset is equal to zero. When the integer frequency offset is n_{I}=1, continual pilots 110, 112, and 114 are shifted forward one position in the frequency domain, as illustrated in the n_{I}=1 row. When the integer frequency offset is n_{I}=−1, the continual pilots 110, 112, and 114 are shifted backward one position in the frequency domain, as illustrated in the n_{I}=−1 row.

If the positions of continual pilots are found, the integer frequency offset can be estimated. Since positions of the continual pilots are fixed for all frames, two consecutive OFDM symbols can be correlated to find the continual pilot positions.

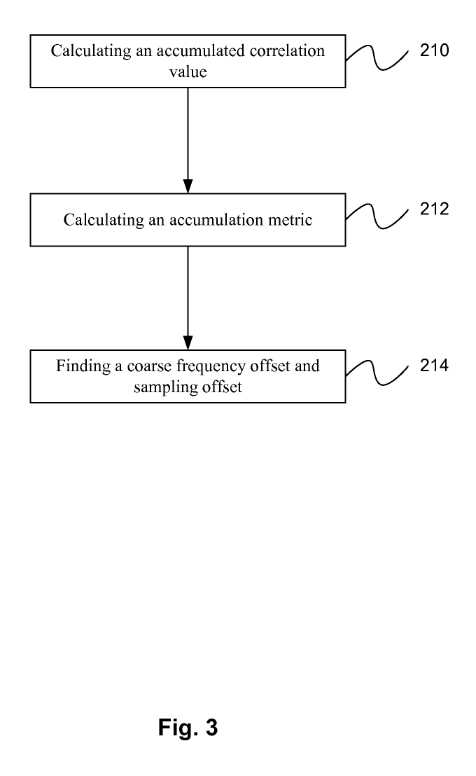

FIG. 3 is a flow chart that illustrates a method of this invention for coarse frequency offset estimation of an OFDM modulated signal. Referring to FIG. 3, the fading channel impact step can be removed by calculating an accumulated correlation value 210 (e.g. the acc_corr(k) calculation illustrated below) over the continual pilots of possible subcarriers by correlating FFT output samples of two consecutive OFDM symbols, l-1 and l; and accumulating the number of symbols, M, where M ranges from 2 to 6, for such correlated FFT outputs;

acc_corr(k)+=round(Z_{l,k}·Z_{l+1,k}/256) (4)

where l=0, 1, 2, 3; z is the FFT output; and M=4.

A metric, herein referred to as an accumulation metric (e.g. the y(m) calculation illustrated below), can be calculated 212 by adding all possible continual pilots, except the adjacent position about 8 KHz of the CCI spectrum peak. Also, by considering the possible phase rotation due to the large sampling offset, the accumulation metric yields

$${y}_{j} ( m ) = \vert {\sum }_{k ∈ C + m} acc\_corr ( k ) * {e}^{{φ}_{j} ( k )} \vert \qquad ( 5 )$$

where k ∉{Peak−8 KHz, peak+8 KHz}. The phase rotation due to the sample offset can be given as,

$${φ}_{j} ( k ) = \{ \begin{matrix}- 2 π ( N + {N}_{g} ) / N * k * ξ & j = 0 \\ 0 & j = 1 \\ 2 π ( N + {N}_{g} ) / N * k * ξ & j = 2\end{matrix} \qquad ( 6 )$$

where the coarse sampling offset is ξ=1e−4 if 100 PPM, and 100 PPM is the sampling offset.

The coarse frequency offset and sampling offset 214 can be found by searching m in the range I=[−n_{I,max}, n_{I,max}] and j, where a maximum accumulation metric is found according to Equation (5). The integer frequency offset (m) can then be obtained by,

$$Δ {{f}^{⋒}}_{I} = \frac{1}{{T}_{u}} \cdot arg {max}_{m ∈ I , j = J} ( {y}_{j} ( m ) ) = 1116 \cdot m \cdot {2}^{2 - n} \qquad ( 7 )$$

where n=0 for 2K mode, n=1 for 4K mode, and n=2 for 8K mode. Note, 1116 in Equation (7) is the distance between the carriers for this example (8K mode), but this value may vary depending on the mode, and is the coarse sampling offset.

The position for each possible continual pilot can be calculated using the following equation:

k=(i+position_continual_pilot(c))% N (8)

where i=[−n_{I,max}, n_{I,max}]; c εC (see Table 2, which gives the number of continual pilots in each mode) where C is the set of the continual pilot positions; and N=2K, 4K, and 8K.

The search range depends on the reference clock. The initial frequency offset can be as large as ±280 kHz. Therefore, n_{I,max} should be set to a value for each mode such that all possible frequency offsets are covered. Table 1 shows the search range for each mode.

While the present invention has been described with reference to certain preferred embodiments, it is to be understood that the present invention is not limited to such specific embodiments. Rather, it is the contention of the inventor that the invention be understood and construed in its broadest meaning as reflected by the following claims. Thus, these claims are to be understood as incorporating not only the preferred embodiments described herein but all those other and further alterations and modifications as would be apparent to those of ordinary skilled in the art.

We claim:

1. A method for calculating coarse frequency offset in demodulating a received signal, comprising the steps of:
removing fading channel impact by calculating accumulated correlation values;
removing CCI and phase rotation by calculating an accumulation metric as a function of the accumulated correlation values, CCI Peak, and a sampling offset ξ; and
finding the coarse frequency offset as a function of the accumulation metric.

2. The method of claim 1 wherein the sampling offset is determined in the finding step as a function of a maximum accumulation metric.

3. The method of claim 1 wherein the accumulated correlation values are calculated by correlating FFT output samples of two consecutive OFDM symbols l-1, l, and accumulating M (M=2-6) of such correlated FFT outputs to generate an accumulating M (acc_corr(k)).

4. The method of claim 3 wherein such removing fading channel step is performed in the frequency domain.

5. The method of claim 1 wherein the accumulation metric is calculated by adding all possible continual pilots and by considering the phase rotation due to the sampling offset, and removing subcarriers around the CCI peak.

6. The method of claim 1 wherein the coarse frequency offset is determined as a function of a maximum accumulation metric.

7. The method of claim 5 wherein the accumulated correlation values are calculated by correlating FFT output samples of two consecutive OFDM symbols l-1, l, and accumulating M (M=2-6) of such correlated FFT outputs to generate an accumulating M (acc_corr(k)).

8. The method of claim 5 wherein such removing fading channel step is performed in the frequency domain.

9. The method of claim 6 wherein the accumulation metric is calculated by adding all possible continual pilots and by considering the phase rotation due to the sampling offset, and removing subcarriers around the CCI peak.

10. The method of claim 3 wherein the coarse frequency offset is determined as a function of a maximum accumulation metric.

11. The method of claim 4 wherein the coarse frequency offset is determined as a function of a maximum accumulation metric.

12. A method for calculating coarse frequency offset in demodulating a received signal, comprising the steps of:
removing fading channel impact by calculating accumulated correlation values;
removing CCI and phase rotation by calculating an accumulation metric as a function of the accumulated correlation values, CCI Peak, and a sampling offset ξ; and
finding the coarse frequency offset as a function of the accumulation metric, wherein the sampling offset is determined as a function of a maximum accumulation metric.

13. The method of claim 12 wherein the accumulated correlation values are calculated by correlating FFT output samples of two consecutive OFDM symbols l-1, l, and accumulating M (M=2-6) of such correlated FFT outputs to generate an accumulating M (acc_corr(k)).

14. The method of claim 13 wherein such removing fading channel step is performed in the frequency domain.

15. The method of claim 12 wherein the accumulation metric is calculated by adding all possible continual pilots and by considering the phase rotation due to the sampling offset, and removing subcarriers around the CCI peak.

16. The method of claim 12 wherein the coarse frequency offset is determined as a function of a maximum accumulation metric.

17. The method of claim 16 wherein the accumulation metric is calculated by adding all possible continual pilots and by considering the phase rotation due to the large sampling offset, and removing subcarriers around the CCI peak.

18. The method of claim 17 wherein such removing fading channel step is performed in the frequency domain.

19. The method of claim 17 wherein the coarse frequency offset is determined as a function of a maximum accumulation metric.

20. A method for calculating coarse frequency offset in demodulating a received signal, comprising the steps of:
removing fading channel impact by calculating accumulated correlation values, wherein the accumulated correlation values are calculated by correlating FFT output samples of two consecutive OFDM symbols l-1, l, and accumulating M (M=2-6) of such correlated FFT outputs to generate an accumulating M (acc_corr(k)), wherein such removing fading channel step is performed in the frequency domain;
removing CCI and phase rotation by calculating an accumulation metric as a function of the accumulated correlation values, CCI Peak, and a sampling offset ξ, wherein the accumulation metric is calculated by adding all possible continual pilots and by considering the phase rotation due to the sampling offset, and removing subcarriers around the CCI peak; and
finding the coarse frequency offset as a function of the accumulation metric, wherein the coarse frequency offset is determined as a function of a maximum accumulation metric and wherein the sampling offset is determined as a function of the maximum accumulation metric.
